(19) United States
(12) Patent Application Publication
(10) Pub. No.: US 2019/0331170 A1
(43) Pub. Date: Oct. 31, 2019

(54) GEAR POWER TRANSMITTING MECHANISM

(71) Applicant: AISIN SEIKI KABUSHIKI KAISHA, Kariya-shi, Aichi-ken (JP)

(72) Inventor: Katsuhiro Tsujimoto, Toyota-shi, Aichi-ken (JP)

(73) Assignee: AISIN SEIKI KABUSHIKI KAISHA, Kariya-shi, Aichi-ken (JP)

(21) Appl. No.: 16/347,335

(22) PCT Filed: Nov. 2, 2017
(86) PCT No.: PCT/JP2017/039687

§ 371 Date: May 3, 2019

(30) Foreign Application Priority Data
Dec. 8, 2016 (JP) 2016-238194

(51) Int. Cl. F16D 3/04; F01L 1/352

(52) U.S. Cl. CPC F16D 3/04; F16H 1/10; F01L 1/352

(57) ABSTRACT

In a housing, accommodated are an internal gear, an external gear, an eccentric axis member and an Oldham coupling member. The external gear is arranged with a part of external teeth being meshed with the internal gear, and supported to be rotatable about an eccentric axis, which is offset by a predetermined distance from a rotation axis in parallel therewith on a plane including the rotation axis, and the Oldham coupling member has a guide hole receiving therein a barrel axis portion of the eccentric axis member, so that the barrel axis portion is supported to be rotatable in the guide hole. On a rotating surface of the external gear facing the Oldham coupling member, held are shaft members, about which slide members are supported to be rotatable, so that the Oldham coupling member is supported to be slidable relative to the external gear through the slide members.

### TECHNICAL FIELD

The present invention relates to a gear power trans mechanism for transmitting a rotating motion through an Oldham coupling.

### BACKGROUND ART

With respect to a gear power transmitting mechanism for transmitting a rotating motion through an Oldham coupling, in Patent document 1 as listed below for example, as to a phase adjustment mechanism used for “a valve opening and closing timing control apparatus controlling a relative rotation phase between a driving-side rotation member which rotates synchronously with a crankshaft and a driven-side rotation member which is supported to be rotatable relative to the driving-side rotation member and which integrally rotates with at least one of an intake camshaft and an exhaust camshaft”, such a configuration as “the phase adjustment mechanism including an output gear arranged coaxially with the rotation axis and fixed to the driven-side rotation member and an input gear arranged coaxially with an eccentric axis which is parallel to the rotation axis and connected to the driving-side rotation member through an Oldham coupling, the input gear being configured to rotate relative to the output gear by an angle corresponding to a difference between a teeth number of the output gear and a teeth number of the input gear based on a revolution of a position of the eccentric axis about the rotation axis by the driving force of the electric actuator in a state where a part of a teeth portion of the output gear is meshed with a part of a teeth portion of the input gear, wherein the Oldham coupling includes an Oldham ring arranged between the driving-side rotation member and the input gear, and wherein between the driving-side rotation member and the Oldham coupling, and between the Oldham ring and the input gear, a linear groove portion being provided at one of the members facing each other and a rectangular protruding portion being provided at the other of the members are slidably engaged” is proposed (described in Paragraphs 0001 and 0009 of Patent document 1), and an embodiment thereof is disclosed in FIG. 4 of the same document.

### PRIOR ART DOCUMENT

### Patent Document

[Patent document 1] Japanese Patent Laid-open Publication No. 2016-44627

### SUMMARY OF THE INVENTION

### Problems to be Solved by the Invention

The Oldham coupling as disclosed in the above-described Patent document 1 is the one provided for the phase adjustment mechanism of the valve opening and closing timing control apparatus, including the Oldham ring arranged between the driving-side rotation member and the input gear, and having such a specific configuration that between the driving-side rotation member and the input gear, and between the Oldham ring and the input gear, the linear groove portion being provided at one of the members facing each other and the rectangular protruding portion being provided at the other of the members are slidably engaged. In general, however, it is based on such a configuration that an Oldham ring (Oldham coupling member) disposed between an external gear, which is meshed with an internal gear accommodated in a housing, and the housing, is supported to be slidable relative to the external gear and the housing. According to this configuration, a sliding friction loss particularly caused between the external gear and the Oldham coupling member largely affects a rotation transmission efficiency. In the case where lubrication of contact surface is insufficient, therefore, a significant decrease in efficiency might be caused.

Accordingly, it is an object of the present invention, with respect to a gear power transmitting mechanism for transmitting a rotating motion through an Oldham coupling, to provide the gear power transmitting mechanism, which is capable of ensuring a smooth sliding operation of an Oldham coupling member.

### Means for Solving the Problems

In order to solve the above-described problem, the present invention related to a gear power transmitting mechanism, which comprises a housing; an internal gear accommodated in the housing, and supported to be rotatable about a predetermined rotation axis relative to the housing, an external gear arranged with a part thereof being meshed with a part of the internal gear, and supported to be rotatable about an eccentric axis, which is offset by a predetermined distance from the rotation axis in parallel therewith on a plane including the rotation axis, an eccentric axis member provided with a barrel axis portion thereof, an input axis portion having an axis thereof on the rotation axis and an eccentric axis portion having an axis thereof on the eccentric axis, which are provided at opposite sides of the barrel axis portion, the eccentric axis portion being rotatably supported by the external gear, and the input axis portion being rotatably supported by the housing, an Oldham coupling member having a guide hole receiving therein the barrel axis portion of the eccentric axis member, so that the barrel axis portion is supported to be rotatable in the guide hole, the Oldham coupling member being supported to be slidable relative to the housing, and being supported to be slidable relative to the external gear in a direction perpendicular to a sliding direction of the Oldham coupling member relative to the housing, a shaft member held on a rotating surface of the external gear facing the Oldham coupling member, and a slide member supported so as to be rotatable about the shaft member, so that the Oldham coupling member is supported to be slidable relative to the external gear through the slide member.

In the above-described gear power transmitting mechanism, it may be so configured that the Oldham coupling member has a groove portion extending in a radial direction from the eccentric axis, and that the slide member is fitted into the groove portion and supported to be slidable relative thereto.

The slide member may be formed in a rectangular shape, which is long in the radial direction. Or, it may be configured by a cylindrical rotation member, which is rotatably supported by the shaft member. The shaft member may be so configured to be fixed to the external gear.

### Effects of the Invention

As the present invention is configured as described above, the following effects are achieved. That is, the gear power transmitting mechanism of the present invention comprises a housing, an internal gear accommodated in the housing, and supported to be rotatable about a predetermined rotation axis relative to the housing, an external gear arranged with a part thereof being meshed with a part of the internal gear, and supported to be rotatable about an eccentric axis, which is offset by a predetermined distance from the rotation axis in parallel therewith on a plane including the rotation axis, an eccentric axis member provided with a barrel axis portion thereof, an input axis portion having an axis thereof on the rotation axis and an eccentric axis portion having an axis thereof on the eccentric axis, which are provided at opposite sides of the barrel axis portion, the eccentric axis portion being rotatably supported by the external gear, and the input axis portion being rotatably supported by the housing, an Oldham coupling member having a guide hole receiving therein the barrel axis portion of the eccentric axis member, so that the barrel axis portion is supported to be rotatable in the guide hole, the Oldham coupling member being supported to be slidable relative to the housing, and being supported to be slidable relative to the external gear in a direction perpendicular to a sliding direction of the Oldham coupling member relative to the housing, a shaft member held on a rotating surface of the external gear facing the Oldham coupling member, and a slide member supported to be rotatable about the shaft member, so that the Oldham coupling member is supported to be slidable relative to the external gear through the slide member, whereby a smooth sliding operation of the Oldham coupling member relative to the external gear can be ensured, to improve wear resistance. Furthermore, only the slide member may be formed by oil retaining material, and/or a solid lubrication film may be applied thereto, so that parts unit price can be suppressed.

In the above-described gear power transmitting mechanism, if it is so configured that the Oldham coupling member has a groove portion extending in a radial direction from the eccentric axis, and that the slide member is fitted into the groove portion and supported to be slidable relative thereto, reduction in size and weight can be achieved. If the above-described slide member is formed in a rectangular shape, which is long in the radial direction, it can be easily formed by oil retaining material, to ensure a smooth sliding operation.

Or, if the above-described slide member is configured by a cylindrical rotation member, which is rotatably supported by the shaft member, rolling contact is made between the cylindrical rotation member and the Oldham coupling member, so that further smooth operation is ensured, to improve wear resistance furthermore.

### BRIEF DESCRIPTION OF THE DRAWINGS

FIG. 1 is a disassembled perspective view of an apparatus including a gear power transmitting mechanism according to an embodiment of the present invention.

FIG. 2 is a perspective view showing an embodiment of slide members and shaft members mounted on an external gear according to an embodiment of the present invention.

FIG. 3 is a perspective view showing another embodiment of slide members and shaft members mounted on an external gear according to an embodiment of the present invention.

FIG. 4 is a perspective view showing another embodiment of an Oldham coupling member provided for an embodiment of the present invention.

### EMBODIMENTS FOR CARRYING OUT THE INVENTION

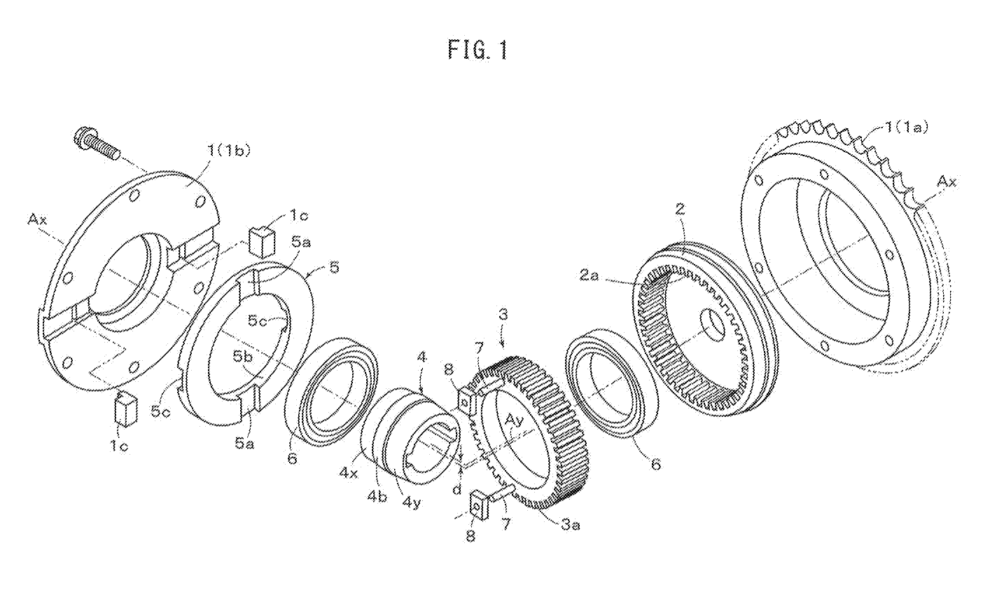

Hereinafter, will be explained a desirable embodiment of the present invention referring to drawings. A gear power transmitting mechanism according to an embodiment of the present invention is shown in FIG. 1 to be disassembled into its component members, such that in a housing 1 accommodated are an internal gear 2, an external gear 3, an eccentric axis member 4 and an Oldham coupling member 5. The internal gear 2 of an annular shape is supported to be rotatable about a predetermined rotation axis (Ax) relative to the housing 1. The external gear 3 is also of an annular shape, and is arranged with a part of its external teeth being meshed with a part of internal teeth of the internal gear 2, and supported to be rotatable about an eccentric axis (Ay), which is offset by a predetermined distance (d) from the rotation axis (Ax) in parallel therewith on a plane including the rotation axis (Ax). The housing 1 includes a cylindrical case 1a and a plate 1b connected thereto by bolts, blocks 1c, 1c are fixed in groove portions formed in a radial direction of the plate 1b, and disposed in such a manner that their tip end portions protrude from the planer surface of the plate 1b. On an outer peripheral surface of the case 1a, formed is a sprocket, which is used when it is provided for the valve opening and closing timing control apparatus as described in the aforementioned Patent document 1.

Around the outer periphery of the external gear 3, there are formed a plurality of teeth portion 3a, number of teeth of which is smaller than the number of teeth of a plurality of teeth portion 2a that are formed around the inner periphery of the internal gear 2. In practice, the number of teeth of the teeth portion 3a of the external gear 3 is set to be smaller by one than the number of teeth of the teeth portion 2a of the internal gear 2 (e.g., if the number of teeth of the internal gear 2 is set to be 100, then the number of teeth of the external gear 3 is set to be 99). And, a part of the teeth portion 2a of the internal gear 2 to be rotated about the rotation axis (Ax) is arranged to mesh with a part of the teeth portion 3a of the external gear 3 to be rotated about the eccentric axis (Ay), which is offset from the rotation axis (Ax).

As shown in FIG. 1, the eccentric axis member 4 is provided with a barrel axis portion 4b, an input axis portion 4x having an axis thereof on the rotation axis (Ax) and an eccentric axis portion 4y having an axis thereof on the eccentric axis (Ay), which are provided at opposite sides of the barrel axis portion 4b. The eccentric axis member 4 is supported by the external gear 3 to be rotatable through a bearing member (bearing) 6, and the input axis portion 4x is supported by the housing 1 (case 1a) to be rotatable through the bearing member 6.

The Oldham coupling member 5 of the present embodiment is formed in an annular plate shape, on a center portion of which a guide hole 5b is formed to receive therein the barrel axis portion 4b of the eccentric axis member 4. On a planar surface at one side of the plate, groove portions 5a, 5a are formed to extend in a radial direction from the eccentric axis (Ay), and on the planar surface at the other side of the plate, groove portions 5c, 5c are formed to extend in a radial direction perpendicular to the radial direction of the groove portions 5a, 5a. Blocks 1c, 1c of the housing 1 are fitted into the groove portions 5c, 5c, respectively, thereby to be supported to be slidable relative thereto.

Furthermore, on a rotating surface of the external gear 3 facing the Oldham coupling member 5, there are formed engaging holes 3c, 3c, into which pins 7, 7 configuring shaft members are pressed, thereby to be fixed to the external gear 3, and slide members 8, 8 of oil retaining material are supported to be rotatable about the pins 7, 7. These slide members 8, 8 are fitted into the groove portions 5a, 5a of the Oldham coupling member 5, respectively, whereby they are supported to be slidable. Consequently, the Oldham coupling member 5 is supported to be slidable in a redial direction relative to the housing 1 (plate 1b), and supported to be slidable in the radial direction perpendicular to its sliding direction relative to the external gear 3.

When the above-described slide members 8, 8 are fitted into the groove portions 5a, 5a of the Oldham coupling member 5, the outer peripheral surface of each slide member 8 will contact either side surface of each groove portion 5a to slide. As the slide member 8 is rotatably supported by the pin 7, a so-called prying caused by errors in manufacturing and assembling processes will not occur, so that a smooth sliding operation will be ensured. According to the present embodiment, it is not necessary to form the whole Oldham coupling member 5 by the oil retaining material, for example, but only the slide member 8 may be formed by the oil retaining material, and/or a solid lubrication film may be applied thereto, so that parts unit price can be suppressed.

According to the gear power transmitting mechanism of the present embodiment, therefore, in the case where the eccentric axis member 4 is rotated about the rotation axis (Ax) by means of an actuator (not shown), the Oldham coupling member 5 is rotated about the eccentric axis (Ay), with the slide members 8, 8 fitted into its groove portions 5a, 5a sliding therein, its rotation driving force is transmitted to the external gear 3 through the pins 7, 7, and the external gear 3 rotates within the internal gear 2, with a part of the teeth portion 3a being meshed with a part of the teeth portion 2a of the internal gear 2, so that the internal gear 2 is rotated about the rotation axis (Ax). During this operation, the Oldham coupling member 5 rotates with being moved in such a direction that radial displacements of the groove portions 5a, 5a and radial displacements of the groove portions 5c, 5c are combined in accordance with the offset amount (“d” as described before), the rotation driving force is transmitted to the external gear 3, and further transmitted to the internal gear 2 in such a manner as described before. As the meshed part in this case is only the one part between the external gear 3 and the internal gear 2, noise can be suppressed to be low as a whole. Furthermore, the smooth sliding operation can be ensured between the external gear 3 and the Oldham coupling member 5 by means of the slide members 8, 8, as described above.

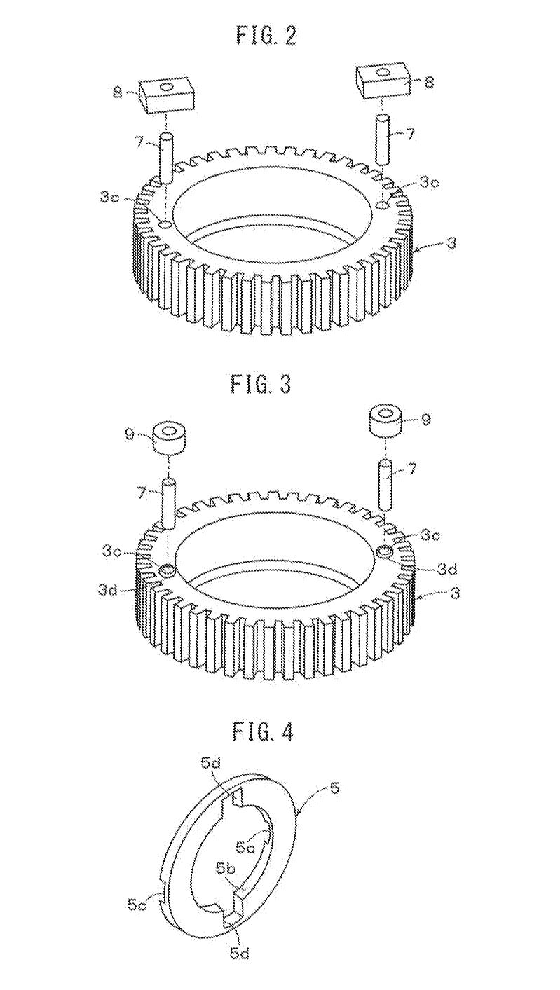

The above-described slide members 8, 8 are formed in the rectangular shape, which is long in the radial direction, as shown in FIG. 2. Instead, as shown in FIG. 3, may be employed cylindrical rotation members 9, 9, which are supported to be rotatable about the pins 7, 7. In FIG. 3, in order to reduce further the friction resistance caused when the cylindrical rotation members 9, 9 rotate, it is so configured that protrusions 3d, 3d are provided to extend from the planar surface of the external gear 3 around the engaging holes 3c, 3c of the external gear 3, and that the cylindrical rotation members 9, 9 slide on their tip end surfaces. Consequently, when the cylindrical rotation members 9, 9 are fitted into the groove portions 5a, 5a of the Oldham coupling member 5, rolling contact is made between the outer peripheral surface of each cylindrical rotation member 9 and either side surface of each groove portion 5a, further smooth operation is ensured, to improve wear resistance.

If the Oldham coupling member 5 is formed with recess portions 5d, 5d to embrace the above-described groove portions 5a, 5a, as shown in FIG. 4, its thickness can be reduced, to minimize its size and weight. Furthermore, if it is provided for the valve opening and closing timing control apparatus as described in the Patent document 1, necessary additions or modifications may be applied appropriately, while omitted in FIG. 1. The gear power transmitting mechanism of the present invention may be applied to not only the above-described valve opening and closing timing control apparatus, but also various devices, with the Oldham coupling member and etc. being configured to conform to those devices.

### DESCRIPTION OF CHARACTERS

1 housing
1a case
1b plate
2 internal gear
2a teeth portion
3 external gear
3a teeth portion
4 eccentric axis member
4b barrel axis portion
4x input axis portion
4y eccentric axis portion
5 Oldham coupling member
5a, 5c groove portion
5b guide hole
6 bearing member
7 pin (shaft member)
8 slide member
9 cylindrical rotation member

1. A gear power transmitting mechanism comprising:
a housing;
an internal gear accommodated in the housing, and supported to be rotatable about a predetermined rotation axis relative to the housing;
an external gear arranged with a part thereof being meshed with a part of the internal gear, and supported to be rotatable about an eccentric axis, which is offset by a predetermined distance from the rotation axis in parallel therewith on a plane including the rotation axis;
an eccentric axis member provided with a barrel axis portion thereof, an input axis portion having an axis thereof on the rotation axis and an eccentric axis portion having an axis thereof on the eccentric axis, which are provided at opposite sides of the barrel axis portion, the eccentric axis portion being rotatably supported by the external gear, and the input axis portion being rotatably supported by the housing;
an Oldham coupling member having a guide hole receiving therein the barrel axis portion of the eccentric axis member, so that the barrel axis portion is supported to be rotatable in the guide hole, the Oldham coupling member being supported to be slidable relative to the housing, and being supported to be slidable relative to the external gear in a direction perpendicular to a sliding direction of the Oldham coupling member relative to the housing;
a shaft member held on a rotating surface of the external gear facing the Oldham coupling member; and
a slide member supported to be rotatable about the shaft member, so that the Oldham coupling member is supported to be slidable relative to the external gear through the slide member.

2. The gear power transmitting mechanism as recited in claim 1, wherein the Oldham coupling member has a groove portion extending in a radial direction from the eccentric axis, the slide member being fitted into the groove portion and supported to be slidable relative thereto.

3. The gear power transmitting mechanism as recited in claim 1, wherein the slide member is formed in a rectangular shape, which is long in the radial direction.

4. The gear power transmitting mechanism as recited in claim 1, wherein the slide member is configured by a cylindrical rotation member, which is rotatably supported by the shaft member.

5. The gear power transmitting mechanism as recited in claim 1, wherein the shaft member is fixed to the external gear.
